(19) United States
(12) Patent Application Publication
(10) Pub. No.: US 2022/0068551 A1
(43) Pub. Date: Mar. 3, 2022

(54) METHOD FOR MANUFACTURING MULTILAYER INDUCTANCE COMPONENT

(71) Applicant: Ralec Electronic Corporation, Kaohsiung (TW)

(72) Inventor: Tim WANG, Kaohsiung (TW)

(21) Appl. No.: 17/246,257

(22) Filed: Apr. 30, 2021

(30) Foreign Application Priority Data
Aug. 31, 2020 (TW) 109129740

(51) Int. Cl. H01F 27/28; H01F 17/00; H01F 41/04; H01F 27/32

(52) U.S. Cl. CPC H01F 27/2847; H01F 17/0013; H01F 2017/0066; H01F 27/324; H01F 41/041

(57) ABSTRACT

A method for manufacturing a multilayer inductance component includes forming through holes to define coil forming regions on an insulating sheet, forming conductive blocks in the through holes and first coil pattern layers at the coil forming regions, forming a guiding block on the first coil pattern layer, removing predetermined parts of the insulating sheet, forming a first magnetic layer partially exposing the guiding block, forming second coil pattern layers connected with the first coil pattern layers, forming inner pads connected to the second coil pattern layers, forming a second magnetic layer partially exposing the inner pads, forming outer pads on the inner pads, cutting along a periphery of each coil forming region, and encapsulating each cut individual component.

### CROSS-REFERENCE TO RELATED APPLICATION

This application claims priority of Taiwanese Patent Application No. 109129740, filed on Aug. 31, 2020.

### FIELD

The present disclosure relates to a method for manufacturing a passive electronic component, and more particularly to a method for manufacturing a multilayer inductance component.

### BACKGROUND

Inductance components are widely used in various electronic devices, and with scientific and technological development, different types of inductance components have been designed to cater to diverse needs. For example, an embedded inductance component generally includes a magnetic body, a conductive coil embedded in the magnetic body, and two terminal electrodes which are formed on two sides of the magnetic body and which are respectively connected to two ends of the conductive coil. Such coil-embedded magnetic body enables the inductance component to be smaller in size and weight. Furthermore, the conductive coil could be designed to be in various configurations according to practical requirements, e.g., may be a conductive winding coil, or a multilayer coil including a plurality of conductive pattern layers.

As the application of inductance components becomes more extensive, manufacturing of different types of inductance components is bound to encounter various technical problems. For instance, in the manufacturing of an embedded inductance component which includes a large number of conductive pattern layers, these conductive pattern layers might render structural support insufficient. Therefore, one of the key focuses for those skilled in the art is to propose various manufacturing approaches so as to solve the technical problems currently encountered in the manufacturing of inductance components.

### SUMMARY

Therefore, an object of the present disclosure is to provide a method for manufacturing a multilayer inductance component that can alleviate at least one of the drawbacks of the prior art.

According to the present disclosure, the manufacturing method includes the steps of:

(A) forming a plurality of through holes on an insulating sheet so as to define a plurality of coil forming regions arranged in an array and respectively for serving as substrates of multilayer inductance components to be manufactured;

(B) forming a plurality of conductive blocks in the through holes, and forming, respectively at a top and an opposite bottom of each of the coil forming regions of the insulating sheet, two first coil pattern layers such that the at least one of the conductive blocks interconnects the first coil pattern layers, the conductive blocks and the first coil pattern layers being electrically conductive;

(C) forming at least one guiding block on a surface of each of the first coil pattern layers opposite to the insulating sheet, the guiding block being electrically conductive;

(D) removing predetermined parts of the insulating sheet respectively at the coil forming regions by laser to obtain a first intermediate product;

(E) forming a first magnetic layer at each of the coil forming regions such that the first magnetic layer covers the first intermediate product and exposes a surface of the guiding block facing away from the insulating sheet so as to obtain a second intermediate product;

(F) forming, at each of the coil forming regions, two second coil pattern layers respectively on top and bottom surfaces of the second intermediate product facing away from the insulating sheet so as to obtain a third intermediate product, the second coil pattern layers being electrically conductive, each of the second coil pattern layers being connected to the respective guiding block for being connected with a corresponding one of the first coil pattern layers;

(G) forming a plurality of inner pads on a bottom surface of the third intermediate product facing away from the insulating sheet so as to obtain a fourth intermediate product, the inner pads being respectively connected to the second coil pattern layers having the bottom surface of the third intermediate product, the inner pads being electrically conductive;

(H) forming a second magnetic layer at each of the coil forming regions such that the second magnetic layer covers the fourth intermediate product and exposes surfaces of the inner pads facing away from the insulating sheet so as to obtain a fifth intermediate product;

(I) forming a plurality of outer pads respectively on the exposed surfaces of the inner pads so as to obtain a sixth intermediate product, the outer pads being electrically conductive;

(J) cutting the sixth intermediate product along a periphery of each of the coil forming regions so as to obtain a plurality of individual components that are separated from one another; and

(K) forming an encapsulant to encapsulate a respective one of the individual components such that the encapsulant partially exposes the outer pads so as to obtain the respective multilayer inductance component, the encapsulant being made of a thermosetting polymeric material.

### BRIEF DESCRIPTION OF THE DRAWINGS

Other features and advantages of the present disclosure will become apparent in the following detailed description of the embodiments with reference to the accompanying drawings, of which:

FIG. 1 is a flow chart illustrating the consecutive steps of an embodiment of a method for manufacturing a multilayer inductance component according to the present disclosure;

FIG. 2 is a schematic perspective view illustrating the multilayer inductance component manufactured by the embodiment;

FIG. 3 is an exploded perspective view illustrating the multilayer inductance component;

FIG. 4 is a schematic view illustrating a step of forming through holes in an insulating sheet;

FIG. 5 is a schematic view illustrating a step of forming conductive blocks and first coil pattern layers;

FIG. 6 is a schematic view illustrating a step of forming guiding blocks;

FIG. 7 is a schematic view illustrating two consecutive steps of removing predetermined parts of the insulating sheet and forming first magnetic layers;

FIG. 8 is a schematic view illustrating a step of forming second coil pattern layers;

FIG. 9 is a schematic view illustrating a step of forming inner pads;

FIG. 10 is a schematic view illustrating a step of forming second magnetic layers;

FIG. 11 is a schematic view illustrating a step of forming outer pads; and

FIG. 12 is a schematic view illustrating two consecutive steps of cutting along a periphery of each coil forming region to obtain individual components, and forming an encapsulant so as to obtain the respective multilayer inductance component.

### DETAILED DESCRIPTION

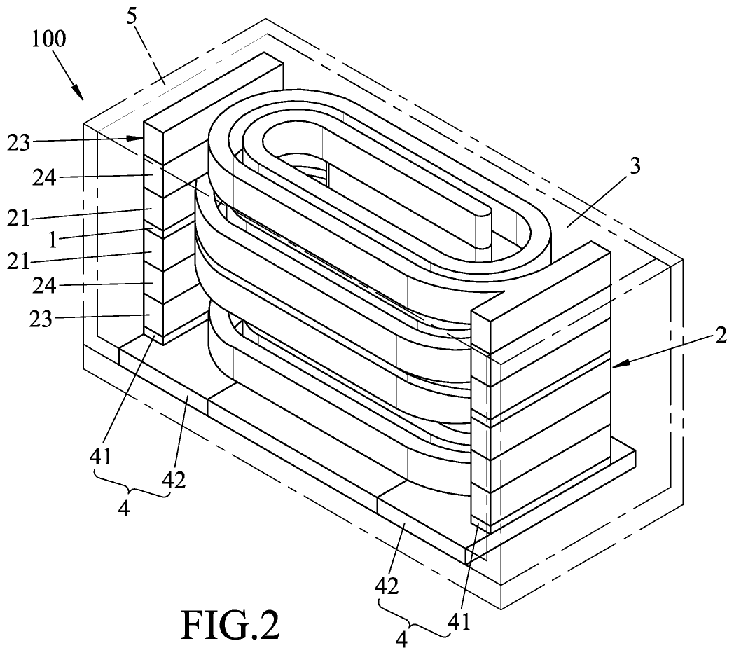

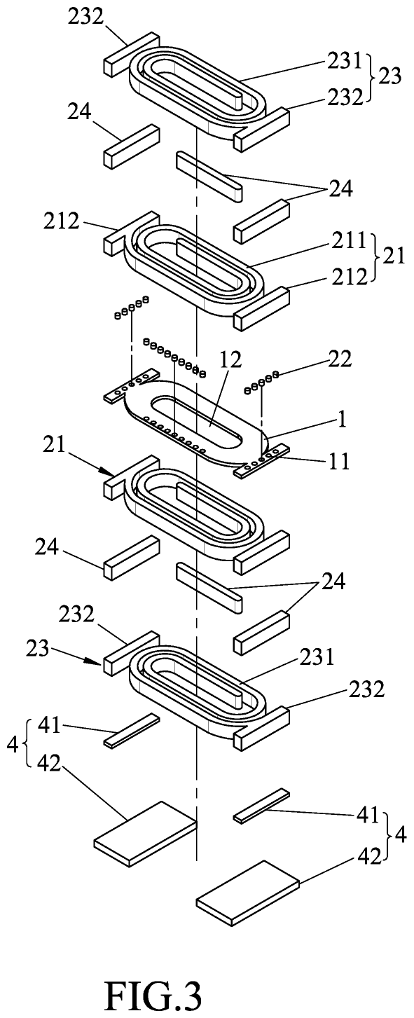

Referring to FIGS. 2 and 3, an embodiment of a multilayer inductance component 100 according to the present disclosure includes a substrate 1, a coil unit 2, two electrodes 4, a magnetic body 3 that covers the coil unit 2 and that covers parts of the electrodes 4, and an encapsulant 5 encapsulating the magnetic body 3.

The substrate 1 is made of an insulating material, and has a plurality of through holes 11 and a hollow region 12.

The coil unit 2 includes two first coil pattern layers 21 respectively formed on opposite top and bottom surfaces of the substrate 1, a plurality of conductive blocks 22 respectively formed in the through holes 11 to interconnect the two first coil pattern layers 21, two second coil pattern layers 23 respectively formed on distal sides of the two first coil pattern layers 21 facing away from the substrate 1, and a plurality of guiding blocks 24 respectively formed on the distal sides of the first coil pattern layers 21 so as to interconnect the respective first coil pattern layer 21 and the corresponding second coil pattern layer 23 on each distal side.

To be specific, each of the first coil pattern layers 21 has a first coiled section 211, and two first straight sections 212 respectively formed on two opposite sides of the first coiled section 211. The first coiled section 211 is connected to one of the first straight sections 212, is not in contact with another one of the first straight sections 212, and has a central hollow portion corresponding in position to the hollow region 12 of the substrate 1. Each of the second coil pattern layers 23 has a second coiled section 231, and two second straight sections 232 respectively formed on two opposite sides of the second coiled section 231. The second coiled section 231 is connected to one of the second straight sections 232, is not in contact with another one of the second straight sections 232, and has a central hollow portion corresponding in position to the hollow region 12 of the substrate 1.

In this embodiment, the two first coil pattern layers 21 are positioned in mirror symmetry with each other relative to the substrate 1, and the two second coil pattern layers 23 are positioned in mirror symmetry with each other relative to the substrate 1.

Each of the guiding blocks 24 is made of an electrically conductive material, such that the respective first coil pattern layer 21 is electrically connected with the corresponding second coil pattern layer 23 on each of the distal sides of the first coil pattern layers 21 through the guiding blocks 24. In this embodiment, three guiding blocks 24 are formed on the distal side of the respective first coil pattern layer 21 opposite to the substrate 1. Specifically, one guiding block 24 electrically connects the first coiled section 211 of the respective first coil pattern layer 21 to the second coiled section 231 of the corresponding second coil pattern layer 23, and two guiding blocks 24 respectively electrically connect the two first straight sections 212 of the respective first coil pattern layer 21 to the two second straight sections 232 of the corresponding second coil pattern layer 23.

The two electrodes 4, each including an inner pad 41 and an outer pad 42, are electrically connected to one of the two second coil pattern layers 23 and serves to connect to an external power source. The inner pads 41 of the electrodes 4 are respectively formed on surfaces of the two second straight sections 232 of the second coil pattern layer 23 facing away from the substrate 1, and the outer pads 42 of the electrodes 4 are respectively formed on surfaces of the inner pads 41 facing away from the substrate 1.

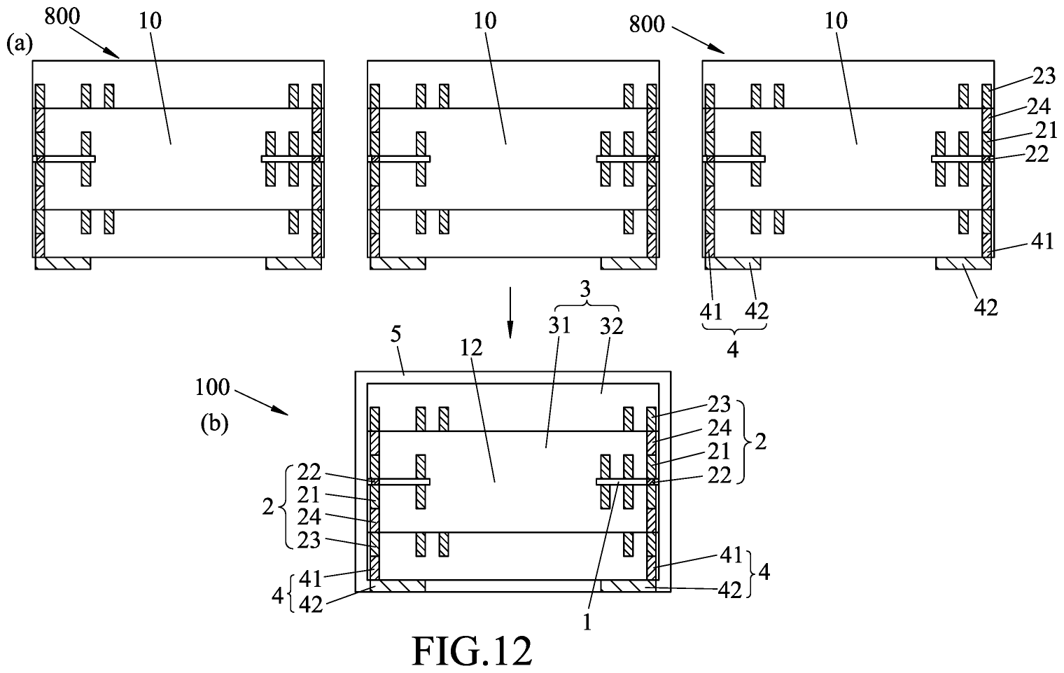

Referring again to FIG. 2, in combination with FIG. 12, the magnetic body 3 includes a first magnetic layer 31 and a second magnetic layer 32. The first magnetic layer 31 covers the substrate 1, the first coil pattern layers 21, and the guiding blocks 24, in such a manner that a portion of the first magnetic layer 31 fills the hollow region 12. The second magnetic layer 32 covers the first magnetic layer 31, the second coil pattern layers 23, and the two inner pads 41, but exposes the surfaces of the two inner pads 41 facing away from the substrate 1 for their connection to the two outer pads 42.

The encapsulant 5 encapsulates the magnetic body 3, and partially exposes the outer pads 42.

By connecting the two first coil pattern layers 21 through the conductive blocks 22, and connecting the respective first coil pattern layer 21 to the corresponding second coil pattern layer 23 on each side of the substrate 1 through the guiding blocks 24, when an external electric current is introduced to the multilayer inductance component 100 through the electrodes 4, the coil unit 2 formed on the top and bottom surfaces of the substrate 1 provides self-inductance and interacts with the magnetic body 3 to generate induced voltage, such that the coil unit 2 serves as an induction coil.

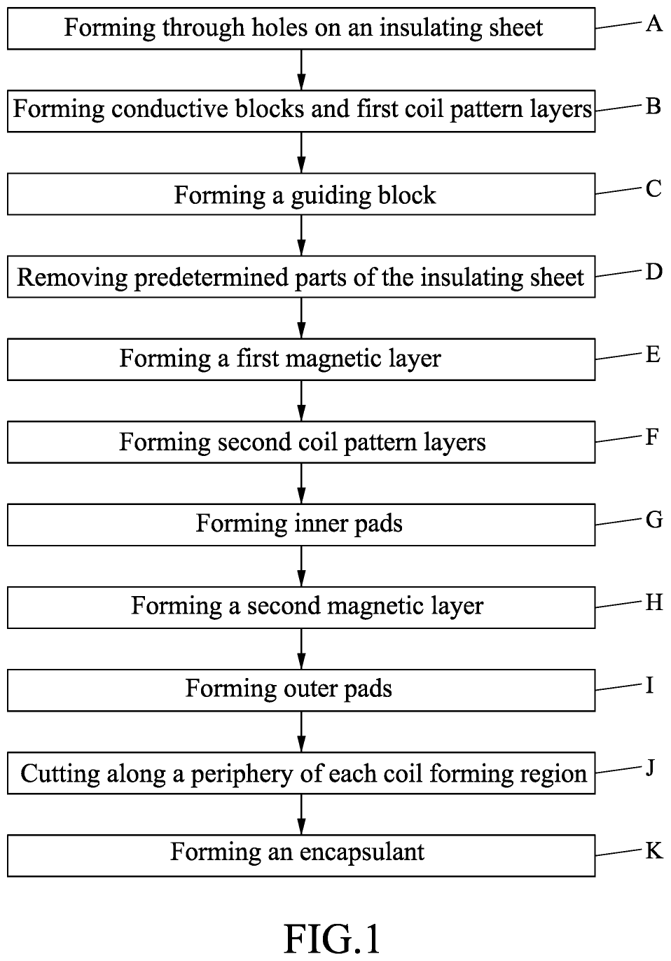

Referring to FIG. 1, an embodiment of a method for manufacturing a plurality of the multilayer inductance components 100 according to the present disclosure includes steps (A) to (K).

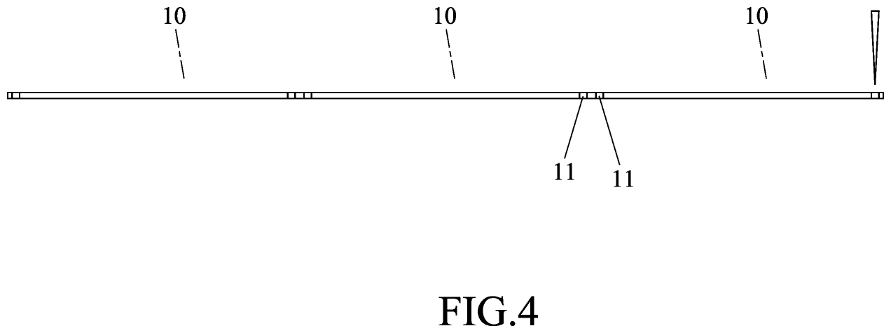

In step (A), referring to FIG. 4, a plurality of the through holes 11 arranged in an array are formed on an insulating sheet using a laser, so as to define a plurality of coil forming regions 10 arranged in an array. The coil forming regions 10 respectively serve as the substrates 1 of the multilayer inductance components 100 to be manufactured, and allow a plurality of the coil units 2 to be formed thereon.

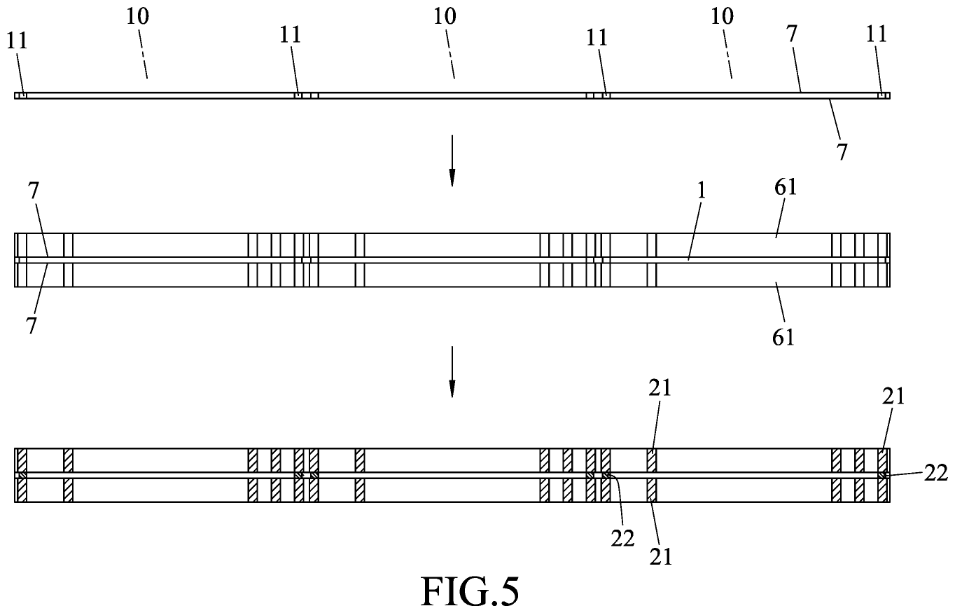

In step (B), referring to FIG. 5, a plurality of the conductive blocks 22 are formed by filling an electrically conductive material in each through hole 11, and then the two electrically conductive first coil pattern layers 21 are respectively formed at a top and an opposite bottom of each of the coil forming regions 10, such that the conductive blocks 22 interconnect the first coil pattern layers 21. In this embodiment, two seed layers 7 made of a copper material are first formed on opposite top and bottom surfaces of the insulating sheet (i.e., the tops and bottoms of the coil forming regions 10) by one of a sputtering process and an electroless plating process, and then two first photoresist films 61 are respectively formed on the two seed layers 7 opposite to the insulating sheet by an adhesion process or a coating process. Afterwards, the first photoresist films 61 are subjected to a photolithography process to remove predetermined portions of the first photoresist films 61 and hence expose portions of the seed layers 7, such that the photoresist films 61 form predetermined patterns at the top and bottom of each of the coil forming regions 10 of the insulating sheet. Subsequently, an electroforming process is performed based on the predetermined patterns so as to form the first coil pattern layers 21 from the seed layers 7.

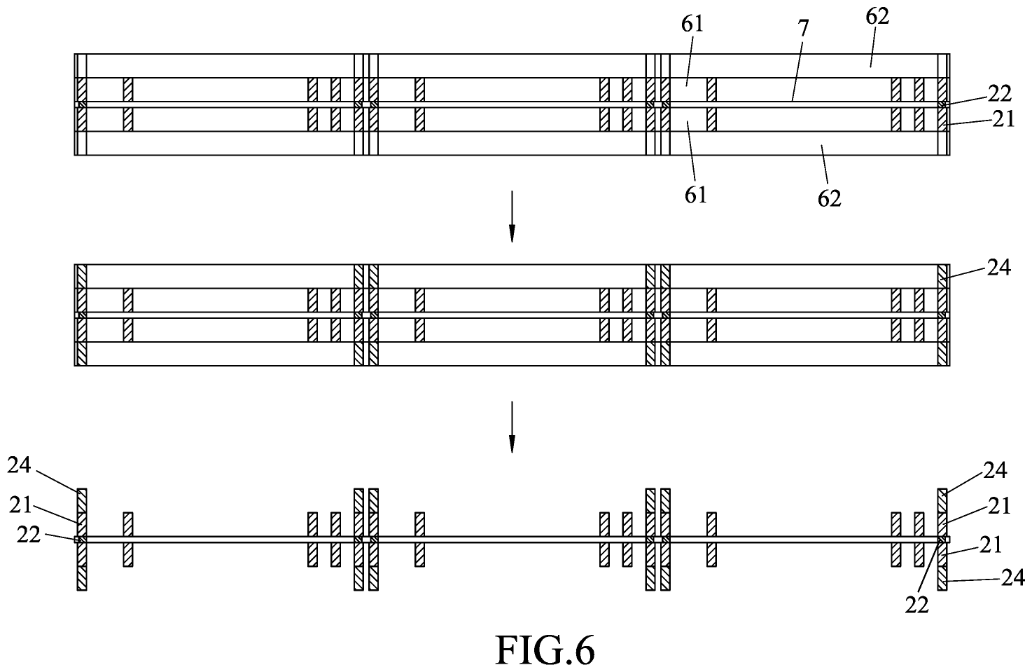

In step (C), referring to FIG. 6, guiding blocks 24 are formed on a surface of each of the first coil pattern layers 21 opposite to the insulating sheet using an electrically conductive material. In this embodiment, two second photoresist films 62 are respectively formed on the two first photoresist films 61 by an adhesion process or a coating process, after which the second photoresist films 62 are subjected to a photolithography process to remove predetermined portions of the second photoresist films 62 and hence partially expose the surfaces of the first coil pattern layers 21 opposite to the insulating sheet. Subsequently, a plurality of the electrically conductive guiding blocks 24 are formed on the exposed surfaces of the first coil pattern layers 21 by an electroforming process, and the two first photoresist films 61, the two second photoresist films 62, and the two seed layers 7 are removed. The seed layers 7 may be removed using an etchant.

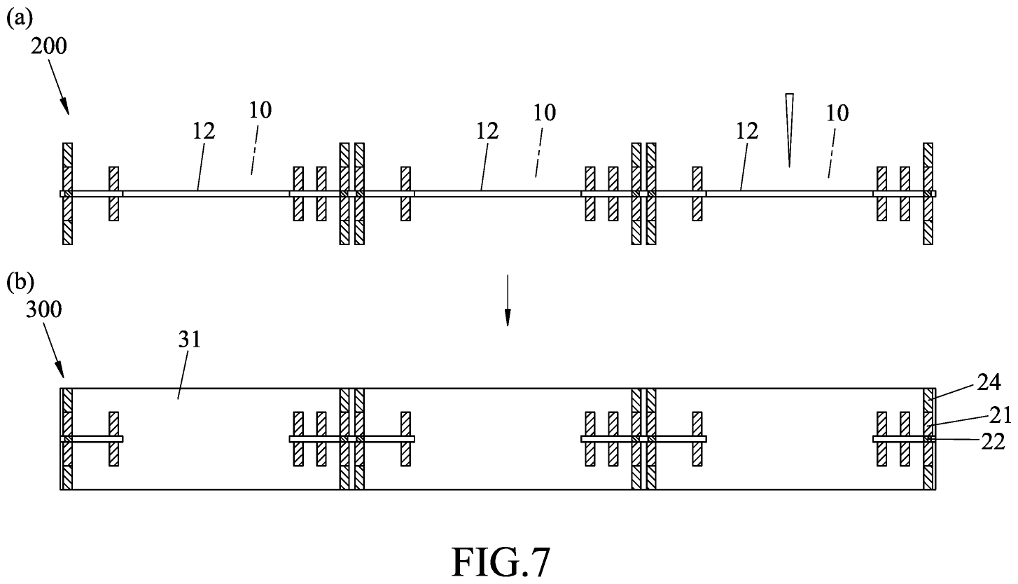

In step (D), referring to FIG. 7(a), predetermined parts of the insulating sheet respectively at the coil forming regions 10 are removed by laser to form the hollow regions 12 that correspond in position to the central hollow portions of the first coiled sections 211 of the first coil pattern layers 21, so as to obtain a first intermediate product 200.

In step (E), referring to FIG. 7(b), at each of the coil forming regions 10, the first magnetic layer 31 is formed by a hot pressing process using a magnetic material, so that the first magnetic layer 31 covers the first intermediate product 200 and exposes surfaces of the guiding blocks 24 facing away from the insulating sheet. Thus, a second intermediate product 300 is obtained.

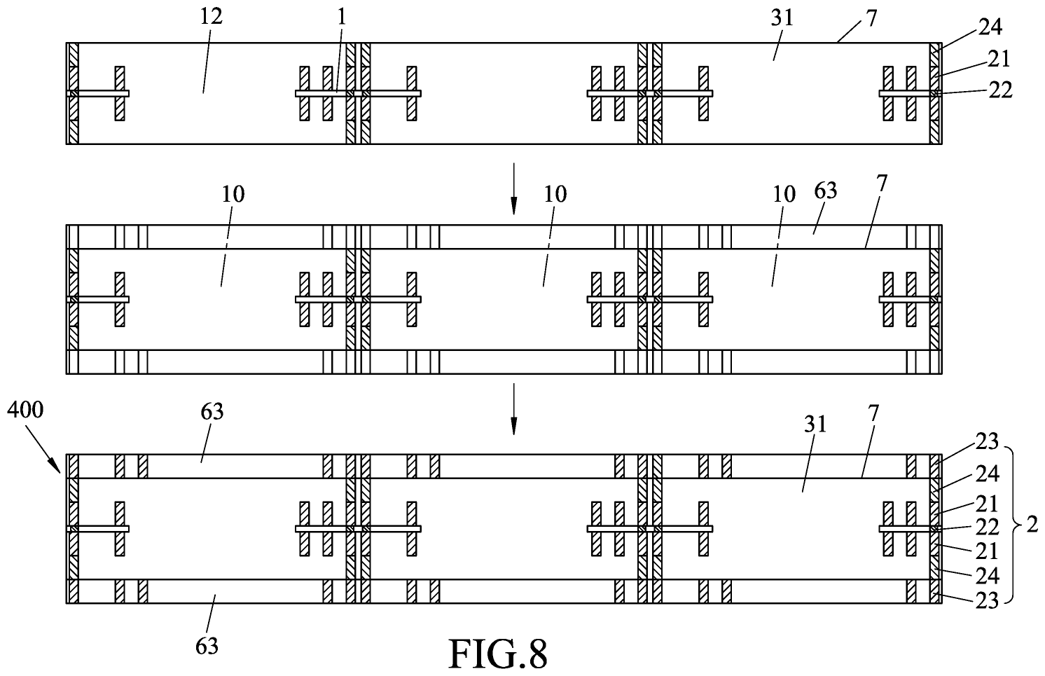

In step (F), referring to FIG. 8, at each of the coil forming regions 10, the two second coil pattern layers 23 are respectively formed on top and bottom surfaces of the second intermediate product 300 facing away from the insulating sheet using an electrically conductive material so as to obtain a third intermediate product 400. In this embodiment, another two seed layers 7 made of a copper material are first formed on the top and bottom surfaces of the second intermediate product 300 where the surfaces of the guiding blocks 24 are exposed by one of a sputtering process and an electroless plating process, and then two third photoresist films 63 are respectively formed on the two seed layers 7 opposite to the second intermediate product 300 by an adhesion process or a coating process. Afterwards, the third photoresist films 63 are subjected to a photolithography process to remove predetermined portions of the third photoresist films 63 and hence partially expose the seed layers 7, such that the third photoresist films 63 form predetermined patterns respectively at the coil forming regions 10 on the top and bottom surfaces of the second intermediate product 300. Subsequently, an electroforming process is performed based on the predetermined patterns so as to form the second coil pattern layers 23 from the seed layers 7. Each of the second coil pattern layers 23 is connected to the respective guiding blocks 24 for being electrically connected with a corresponding one of the first coil pattern layers 21.

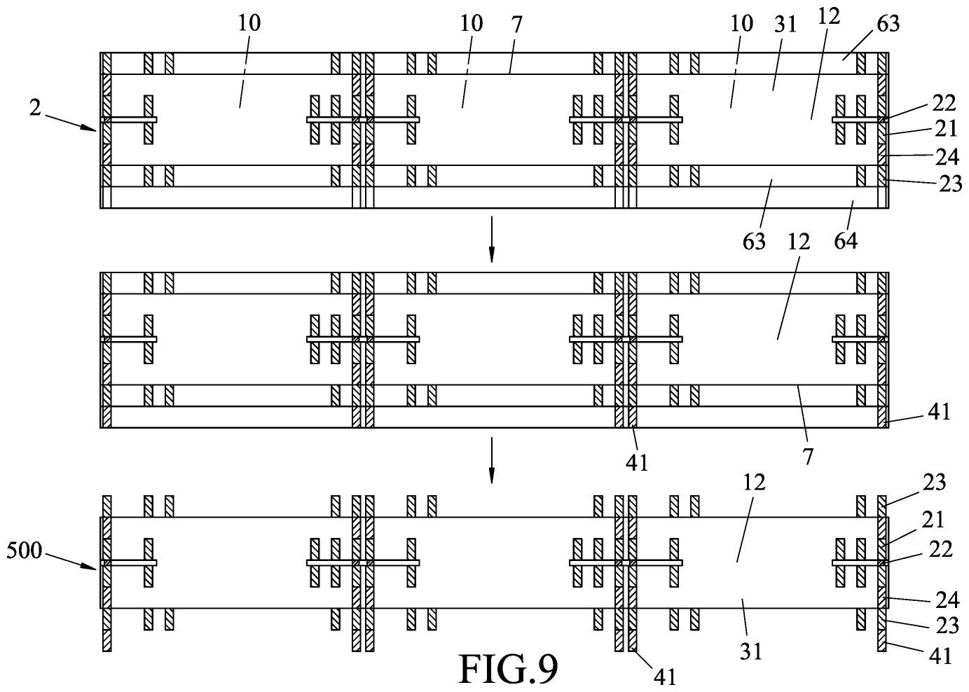

In step (G), referring to FIG. 9, a plurality of inner pads 41 are formed on a bottom surface of the third intermediate product 400 facing away from the insulating sheet using an electrically conductive material so as to obtain a fourth intermediate product 500. In this embodiment, a fourth photoresist film 64 is first formed on the bottom surface of the third intermediate product 400 by an adhesion process or a coating process, and then the fourth photoresist film 64 is subjected to a photolithography process to remove predetermined portions of the fourth photoresist film 64 and hence partially expose surfaces of the second coil pattern layers 23, such that the fourth photoresist film 64 forms predetermined patterns respectively at the coil forming regions 10 on the bottom surface of the third intermediate product 400. Subsequently, an electroforming process is performed based on the predetermined patterns so as to obtain the inner pads 41 that are electrically conductive and that are respectively connected to the second coil pattern layers 23 having the bottom surface of the third intermediate product 400, and the two third photoresist films 63, the fourth photoresist film 64, and the two seed layers 7 are removed, thereby obtaining the fourth intermediate product 500. The seed layers 7 may be removed using an etchant.

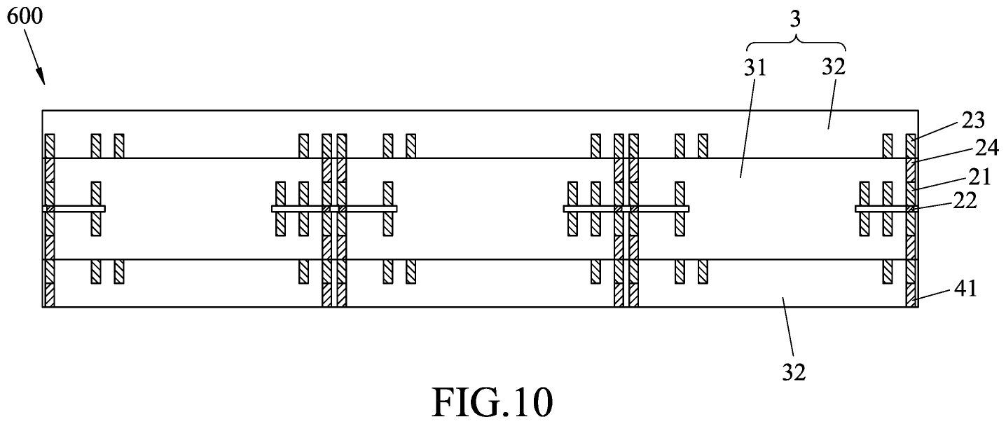

In step (H), referring to FIG. 10, at each of the coil forming regions 10, the second magnetic layer 32 is formed using a magnetic material by a hot pressing process such that the second magnetic layer 32 covers the fourth intermediate product 500 and exposes surfaces of the inner pads 41 facing away from the insulating sheet. Therefore, a fifth intermediate product 600 is obtained.

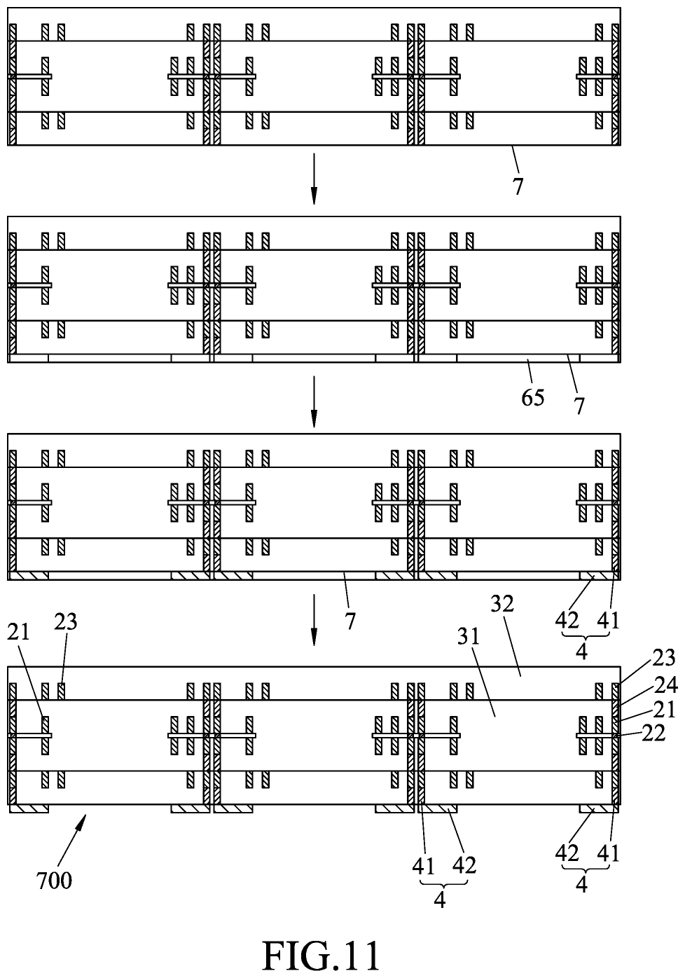

In step (I), referring to FIG. 11, using an electrically conductive material, a plurality of outer pads 42 to be connected to an external power source are formed on the exposed surfaces of the inner pads 41 of the fifth intermediate product 600 facing away from the insulating sheet, such that the outer pads 42 and the inner pads 41 form a plurality of the electrodes 4. Thus, a sixth intermediate product 700 is obtained. In this embodiment, yet another seed layer 7 made of a copper material is first formed on a bottom surface of the fifth intermediate product 600, where the surfaces of the inner pads 41 are exposed, by one of a sputtering process and an electroless plating process, and then a fifth photoresist film 65 is formed on the seed layer 7 opposite to the fifth intermediate product 600 by an adhesion process or a coating process. Afterwards, the fifth photoresist film 65 is subjected to a photolithography process to remove predetermined portions of the fifth photoresist film 65 and hence partially expose the seed layer 7. An electroplating process is conducted to form a plurality of the outer pads 42 on the exposed parts of the seed layer 7 corresponding in position to the previously exposed surfaces of the inner pads 41. Subsequently, the fifth photoresist film 65 and the seed layer 7 are removed, thereby obtaining the sixth intermediate product 700. It should be noted that the outer pads 42 may also be formed by a process selected from the group consisting of sputtering, deposition, and conductive layer bonding. Since such processes are well known to those skilled in the art, further details thereof are not provided herein for the sake of brevity.

In step (J), referring to FIG. 12(a), the sixth intermediate product 700 is cut along a periphery of each of the coil forming regions 10 so as to obtain a plurality of individual components 800 that are separated from one another and that each includes the substrate 1 (i.e., the respective coil forming region 10 of the insulating sheet), the coil unit 2, the magnetic body 3, and the two electrodes 4.

In step (K), referring to FIG. 12 (b), an encapsulant 5 made of a thermosetting polymeric material is formed to encapsulate a respective one of the individual components 800 so that the encapsulant 5 partially exposes the two outer pads 42. Therefore, the multilayer inductance component 100 as shown in FIG. 2 is obtained (only one multilayer inductance component 100 is shown in FIG. 12(b)).

In summary, in the method for manufacturing the multilayer inductance component 100 according to the present disclosure, the first coil pattern layers 21 and the second coil pattern layers 23 of the coil unit 2 are formed on both the top and bottom of the substrate 1. Compared with a conventional manufacturing method, in which all coiled layers are stacked on one surface of a substrate to form a multilayer coil unit, the manufacturing method of the present disclosure can provide sufficient structural support for the coil unit 2 on the substrate 1. In addition, during the manufacturing method of the present disclosure, the first magnetic layer 31 covering the first intermediate product 200 including the first coil pattern layers 21 provides sufficient structural support, preventing the problem of a low production yield of the final product due to insufficient structural support of the intermediate products.

In the description above, for the purposes of explanation, numerous specific details have been set forth in order to provide a thorough understanding of the embodiments. It will be apparent, however, to one skilled in the art, that one or more other embodiments may be practiced without some of these specific details. It should also be appreciated that reference throughout this specification to “one embodiment,” “an embodiment,” an embodiment with an indication of an ordinal number and so forth means that a particular feature, structure, or characteristic may be included in the practice of the disclosure. It should be further appreciated that in the description, various features are sometimes grouped together in a single embodiment, figure, or description thereof for the purpose of streamlining the disclosure and aiding in the understanding of various inventive aspects, and that one or more features or specific details from one embodiment may be practiced together with one or more features or specific details from another embodiment, where appropriate, in the practice of the disclosure.

While the present disclosure has been described in connection with what is considered the exemplary embodiments, it is understood that this disclosure is not limited to the disclosed embodiments but is intended to cover various arrangements included within the spirit and scope of the broadest interpretation so as to encompass all such modifications and equivalent arrangements.

What is claimed is:

1. A method for manufacturing a multilayer inductance component, comprising the steps of:
(A) forming a plurality of through holes on an insulating sheet so as to define a plurality of coil forming regions arranged in an array and respectively for serving as substrates of multilayer inductance components to be manufactured;
(B) forming a plurality of conductive blocks in the through holes, and forming, respectively at a top and an opposite bottom, of each of the coil forming regions of the insulating sheet, two first coil pattern layers such that the at least one of the conductive blocks interconnects the first coil pattern layers, the conductive blocks and the first coil pattern layers being electrically conductive;
(C) forming at least one guiding block on a surface of each of the first coil pattern layers opposite to the insulating sheet, the guiding block being electrically conductive;
(D) removing predetermined parts of the insulating sheet respectively at the coil forming regions by laser to obtain a first intermediate product;
(E) forming a first magnetic layer at each of the coil forming regions such that the first magnetic layer covers the first intermediate product and exposes a surface of the guiding block facing away from the insulating sheet so as to obtain a second intermediate product;
(F) forming, at each of the coil forming regions, two second coil pattern layers respectively on top and bottom surfaces of the second intermediate product facing away from the insulating sheet so as to obtain a third intermediate product, the second coil pattern layers being electrically conductive, each of the second coil pattern layers being connected to the respective guiding block for being connected with a corresponding one of the first coil pattern layers;
(G) forming a plurality of inner pads on a bottom surface of the third intermediate product facing away from the insulating sheet so as to obtain a fourth intermediate product, the inner pads being respectively connected to the second coil pattern layers having the bottom surface of the third intermediate product, the inner pads being electrically conductive;
(H) forming a second magnetic layer at each of the coil forming regions such that the second magnetic layer covers the fourth intermediate product and exposes surfaces of the inner pads facing away from the insulating sheet so as to obtain a fifth intermediate product;
(I) forming a plurality of outer pads respectively on the exposed surfaces of the inner pads so as to obtain a sixth intermediate product, the outer pads being electrically conductive;
(J) cutting the sixth intermediate product along a periphery of each of the coil forming regions so as to obtain a plurality of individual components that are separated from one another; and
(K) forming an encapsulant to encapsulate a respective one of the individual components such that the encapsulant partially exposes the outer pads so as to obtain the respective multilayer inductance component, the encapsulant being made of a thermosetting polymeric material.

2. The method as claimed in claim 1, wherein in step (B), a photolithography process with a photoresist is utilized for the photoresist to form predetermined patterns at the top and bottom of each of the coil forming regions of the insulating sheet, respectively, followed by conducting an electroforming process so as to form the first coil pattern layers.

3. The method as claimed in claim 1, wherein in step (F), a photolithography process with a photoresist is utilized for the photoresist to form predetermined patterns at each of the coil forming regions on the top and bottom surfaces of the second intermediate product, respectively, followed by an electroforming process so as to obtain the second coil pattern layers.

4. The method as claimed in claim 1, wherein in step (G), a photolithography process with a photoresist is utilized for the photoresist to form predetermined patterns at each of the coil forming regions on the bottom surface of the third intermediate product, followed by an electroforming process so as to obtain the inner pads.

5. The method as claimed in claim 1, wherein in step (E), the first magnetic layer is formed by a hot pressing process.

6. The method as claimed in claim 1, wherein in step (H), the second magnetic layer is formed by a hot pressing process.

7. The method as claimed in claim 1, wherein in step (I), the outer pads are formed by electroplating.

8. The method as claimed in claim 1, wherein in step (B), two seed layers made of a copper material are first formed on top and bottom surfaces of the insulating sheet respectively having the tops and bottoms of the coil forming regions, followed by forming the first coil pattern layers from the seed layers.

9. The method as claimed in claim 1, wherein in step (F), two seed layers made of a copper material are first formed on the top and bottom surfaces of the second intermediate product, followed by forming the second coil pattern layers from the seed layers.
